(19) United States
(12) Patent Application Publication
(10) Pub. No.: US 2004/0084920 A1
(43) Pub. Date: May 6, 2004

(54) Security system for a modular system in a vehicle

(75) Inventors: Derek P. Trimble, Simi Valley, CA (US); Adam M. Shane, Pasadena, CA (US); Eric S. Deuel, Allendale, MI (US); Lance M. Hilbelink, Jenison, MI (US); Kim L. Van Order, Hamilton, MI (US); Curt R. Jonson, Holland, MI (US); J. Peter Cansfield, Holland, MI (US); L. Robert Hamelink, Hamilton, MI (US); Dale A. Gort, Holland, MI (US); Kermit M. Anderson, Holland, MI (US)

Correspondence Address: FOLEY & LARDNER, 777 EAST WISCONSIN AVENUE, SUITE 3800, MILWAUKEE, WI, 53202-5308, US

(73) Assignee: Johnson Controls Technology Company

(21) Appl. No.: 10/694,370

(22) Filed: Oct. 27, 2003

Related U.S. Application Data
(63) Continuation-in-part of application No. 09/846,811, filed on May 1, 2001, now Pat. No. 6,669,260.

(51) Int. Cl. B60R 7/04

(52) U.S. Cl. 296/37.8

(57) ABSTRACT

A security system for a modular system in a vehicle is provided and includes at least one elongated member configured for attachment to an interior portion of the vehicle, at least one module configured for attachment to the elongated member, a module interface unit communicating with the elongated member, and an identification unit coupled to the module and configured to interface with the module interface unit, so that the module interface unit is operable to authenticate the module when the module is mounted on the elongated member.

### CROSS REFERENCE TO RELATED APPLICATIONS

The present application is a continuation in part application and incorporates by reference and claims priority to the following copending patent application: U.S. patent application Ser. No. 09/846,811 titled “Modular System for a Vehicle” filed on May 1, 2001.

### FIELD

The present invention relates to a security system for a modular system in a vehicle. The present invention relates more particularly to a security system for use with modules configured for attachment to a rail system within a vehicle.

### BACKGROUND

Modular storage compartments in the forward portion of vehicles are generally known and include consoles and structures for mounting items such as lamps, small storage compartments and electronic instrumentation such as compasses, temperature displays and clocks. Such modular systems typically have mounting configurations that permanently attach such modules to a structural portion of the vehicle, whereby installation of module options are typically conducted in a factory setting during vehicle construction and often requires user-selection of the desired modules prior to vehicle assembly, or user acceptance of preinstalled option packages.

Security systems that monitor assets or persons are also generally known. Such security systems may include devices such as transponders or transmitters attached, for example, to an asset or person to monitor or locate the asset or person and to provide a signal (such as an alarm) in the event that the asset or person is in an unauthorized location.

However, such known security systems do not typically provide an effective system for permitting the use of a module with a particular modular system (e.g. to provide an “authenticating” function), or from preventing a module from a modular system in one particular vehicle from being used with a modular system in another vehicle (e.g. an “anti-theft” function).

Accordingly, it would be advantageous to provide a security system for a modular system in a vehicle for authenticating and protecting a wide array of selectively removable, user-oriented modules that are adapted for use within, or in conjunction with, a vehicle. It would also be advantageous to provide a security system for a modular system in a vehicle that prevents operation of an “unauthorized” module from being used with a particular modular system in a vehicle. It would also be advantageous to provide a security system for a modular system in a vehicle that prevents a module that is authorized for use with a particular modular system in one vehicle from being used in connection with a modular system in another vehicle. It would be further advantageous to provide a security system for a modular system in a vehicle that is reconfigurable to permit a module from one vehicle to be used in another vehicle when properly authorized by the user of the module. It would be further advantageous to provide a security system for a modular system in a vehicle that physically “locks” the module to a modular system in a vehicle when installed by an authorized user, and permits the module to be “unlocked” for removal from the modular system when activated by an authorized user.

Accordingly, it would be advantageous to provide a security system for a modular system for a vehicle having any one or more of these, or other, features.

### SUMMARY

A security system for a modular system in a vehicle includes at least one elongated member configured for attachment to an interior portion of the vehicle, at least one module configured for attachment to the elongated member, a module interface unit communicating with the elongated member, and an identification unit coupled to the module and configured to interface with the module interface unit, so that the module interface unit is operable to authenticate the module when the module is mounted on the elongated member.

A security system for a module for use with a modular system in a vehicle includes at least one elongated member configured for attachment to an interior portion of the vehicle and configured to receive the module, a module interface unit communicating with the elongated member, an identification unit coupled to the module and configured to interface with the module interface unit, and a locking device provided on the module and operable to engage the elongated member in a locked position and a released position.

A modular system for a vehicle includes at least one elongated member configured for installation on an interior surface of the vehicle, a module configured to couple to the elongated member, a vehicle supply source configured to provide at least one of an electrical power supply and a communication signal for use by the module, a module interface unit configured to interface with the vehicle supply source and the module, and an identification unit coupled to the module and configured to authenticate the module for use in the vehicle so that the module interface unit is enabled to provide at least one of an electrical power supply and a communication signal to the module.

### BRIEF DESCRIPTION OF THE DRAWINGS

FIG. 1 is an upward-looking perspective view of a modular system mounted on a vehicle interior according to a preferred embodiment.

FIG. 2A is an upward looking perspective view of a modular system with end cover trim pieces according to a preferred embodiment.

FIG. 2B is an upward looking perspective view of a modular system with end cover trim pieces removed according to a preferred embodiment.

FIG. 3 is a downward looking perspective view of a modular system according to a preferred embodiment.

FIG. 4 is a side elevation of a modular system according to a preferred embodiment.

FIG. 5 is an upward looking bottom view of a modular system according to a preferred embodiment.

FIG. 6 is a cross sectional view of a modular system along line 6-6 of FIG. 3 according to a preferred embodiment.

FIG. 7 is a cross sectional view of an attachment in an engaged position for a modular system along line 7-7 of FIG. 5 according to a preferred embodiment.

FIG. 8 is the cross sectional view of FIG. 7 for the attachment in a released position for a modular system according to a preferred embodiment.

FIG. 9 is the cross sectional view of FIG. 7for the attachment in an engaged position for a modular system according to an alternative embodiment.

FIG. 10 is the cross sectional view of FIG. 7 for the attachment in a released position for a modular system according to an alternative embodiment.

FIG. 11 is the cross sectional view of FIG. 7 for the attachment in an engaged position for a modular system according to another alternative embodiment.

FIG. 12 is the cross sectional view of FIG. 7 for the attachment in a released position for a modular system according to another alternative embodiment.

FIG. 13 is the cross sectional view of FIG. 7 for the attachment in an engaged position for a modular system according to a further alternative embodiment.

FIG. 14 is the cross sectional view of FIG. 7 for the attachment in a released position for a modular system according to a further alternative embodiment.

FIG. 15 is an upward-looking perspective view of a modular system mounted on a vehicle interior according to another preferred embodiment.

FIG. 16 is an upward-looking perspective view of a modular system mounted on a vehicle interior according to another preferred embodiment.

FIG. 17 is a side perspective view of a modular system mounted on a vehicle interior according to another preferred embodiment.

FIG. 18 is a schematic diagram of a security system for a modular system for a vehicle according to an exemplary embodiment.

### DETAILED DESCRIPTION

The security system for a modular system in a vehicle is shown and described for modules configured to attach to elongated members of an overhead portion of a vehicle (shown schematically as “rails” or other elongated members positioned on an “A” surface of a “headliner” or panel). However, the description of the various embodiments of the security system for a modular system in a vehicle are equally applicable to use with modular systems for other locations or surfaces within a vehicle, such a floor areas, cargo storage areas, seat backs, side panels, etc. and with members having other shapes or configurations.

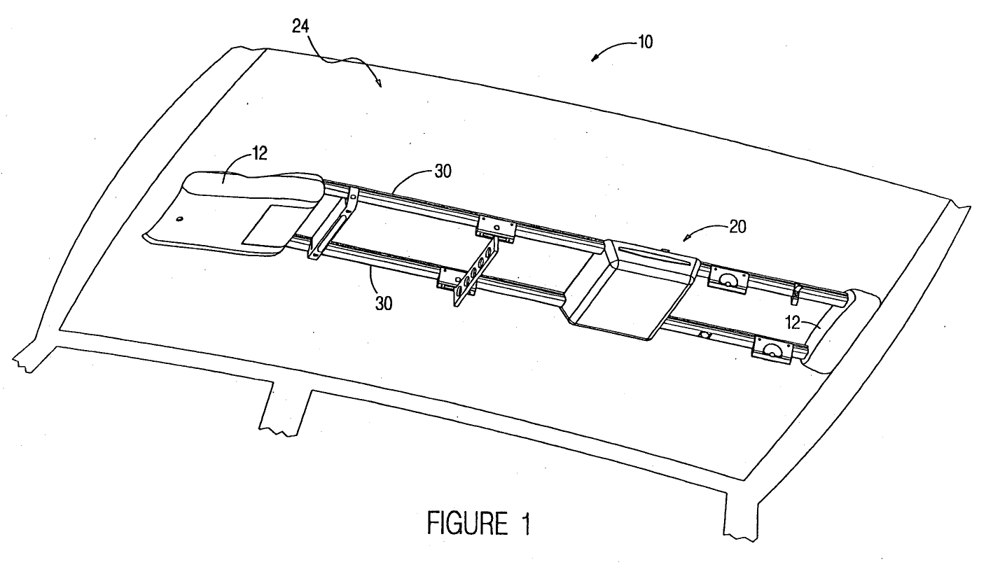

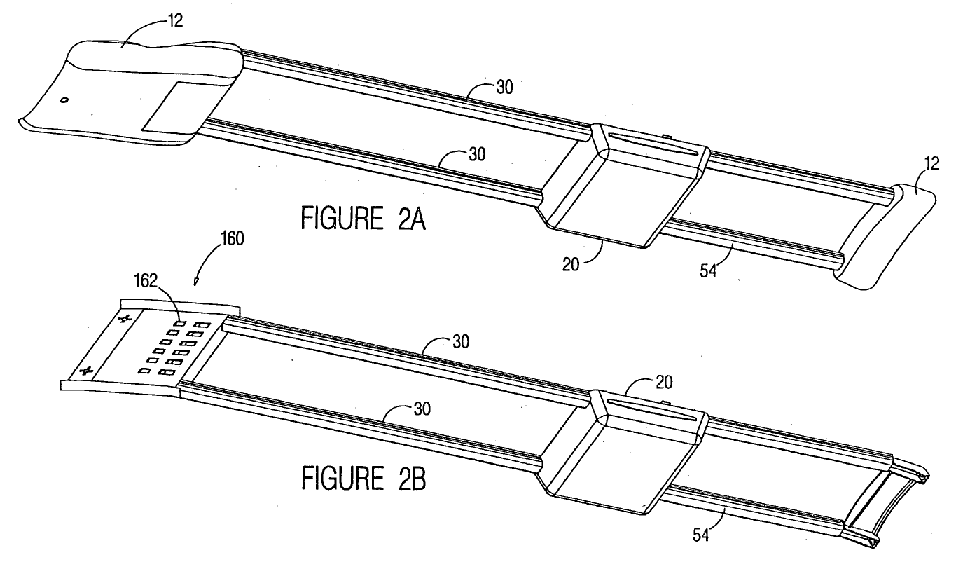

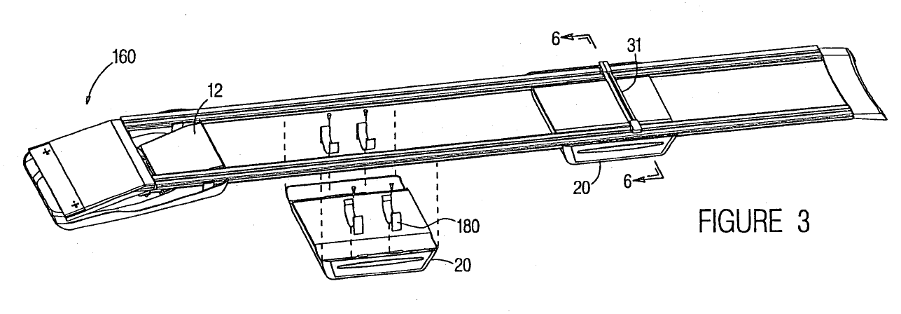

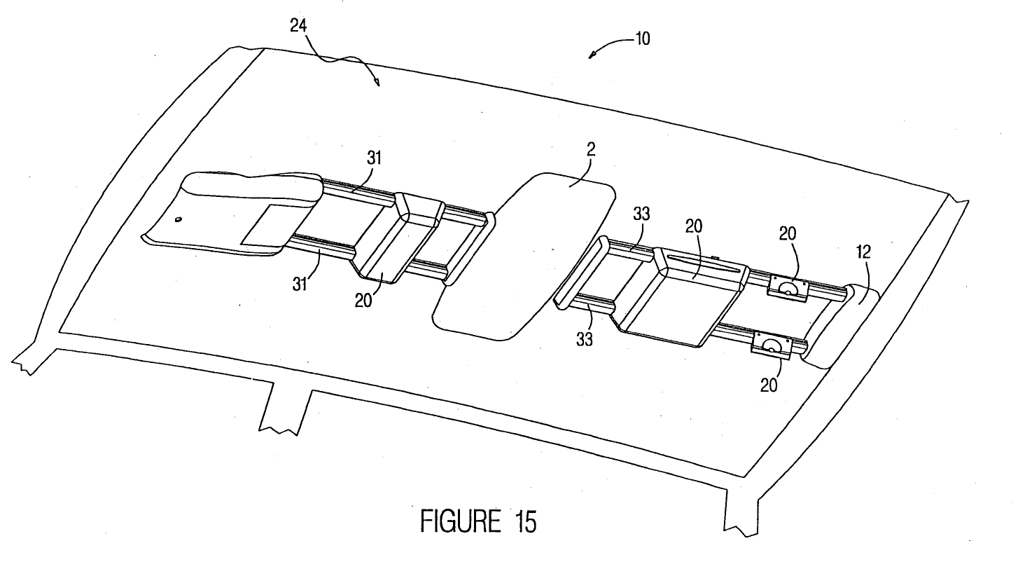

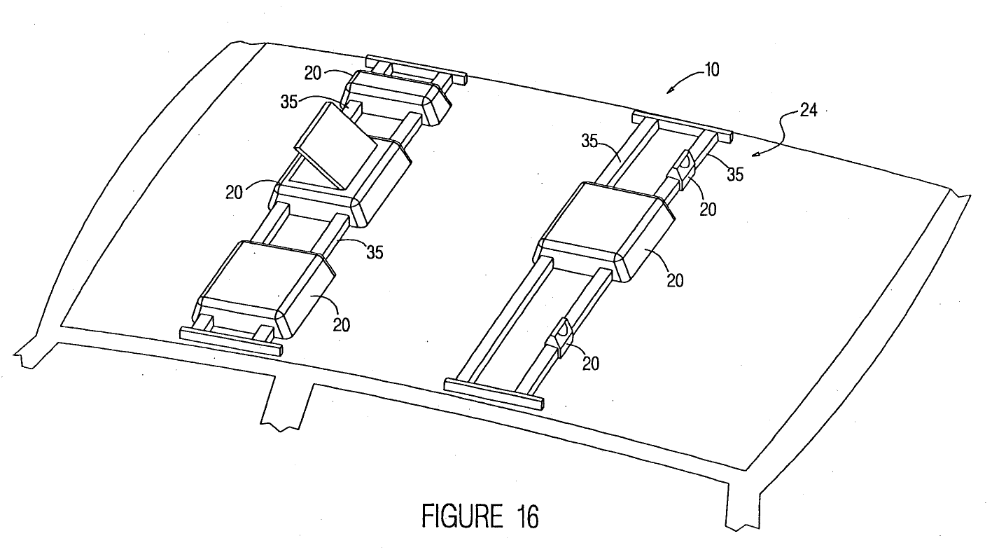

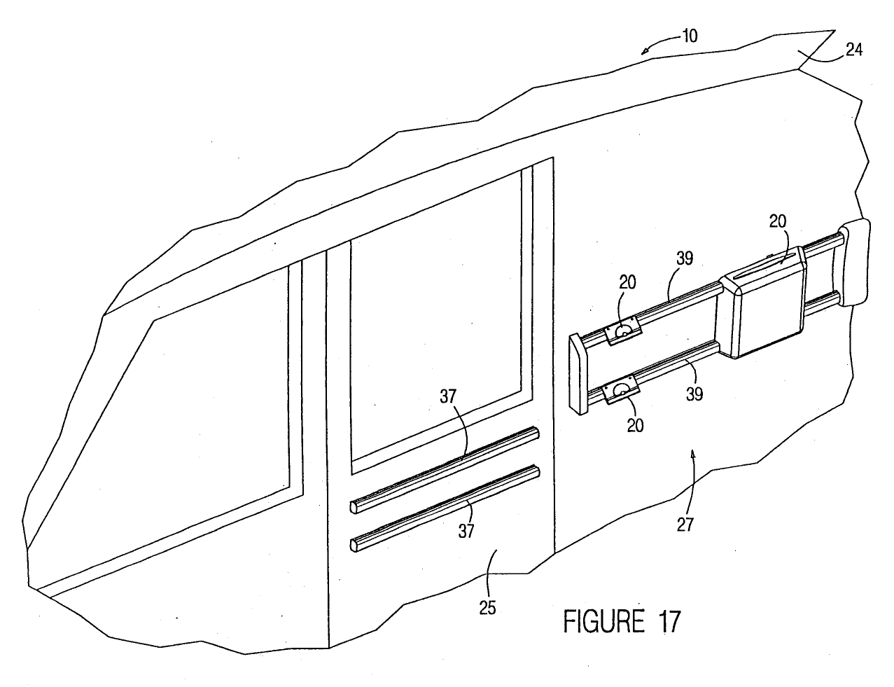

Referring to FIGS. 1 and 2, a modular system 10 for mounting one or more modules 20 is shown schematically (exemplary modules will be further described herein) along an interior panel 24 (e.g. door or side panel, cover, headliner, etc.) of a vehicle according to a preferred embodiment. System 10 may also be adapted for mounting modules 20 along the sides of the vehicle such as door or side panels, or within the interior space of the vehicle such as cargo areas (as shown schematically in FIG. 17), in a manner similar to the method described herein. System 10 includes two generally parallel mounting members (shown as elongated members 30) such as rails, tracks, channels, holders, bars, rods, poles, etc. that are oriented in any desired configuration within a vehicle along interior panel 24. Elongated members 30 have a lateral spacing that is generally fixed for a particular vehicle style, but the spacing may vary between different vehicle styles and models and may have any lateral spacing suitable for mounting modules 20. One or more positioners 31 (shown schematically in FIG. 3) may be used to secure the lateral spacing of elongated members 30 for receiving modules 20. For overhead applications, elongated members 30 may be oriented longitudinally and centered laterally within the vehicle, but may be located at any lateral position on the interior panel 24 to accommodate mounting of modules 20. According to an alternative embodiment, the elongated members may be separated into a forward segment and/or a rearward segment (as shown schematically in FIG. 15) for adapting to roof windows or other discontinuities in the roof structures. Elongated members 30 may also be oriented laterally along interior panel 24 (as shown schematically in FIG. 16) to increase the flexibility and utility of the modular system for interchangeably receiving the modules 20. According to another alternative embodiment, a single elongated member may be used in conjunction with modules that are adapted to selectively and interchangeably engage a single elongated member. According to a further alternative embodiment, the elongated members may be mounted to pillars (not shown) or other generally vertical support columns within the interior space of a vehicle to provide a system for attaching the modules. Such pillars may be secured by interface modules mounted to the elongated members for increased flexibility in attaching modules to the pillar-mounted members.

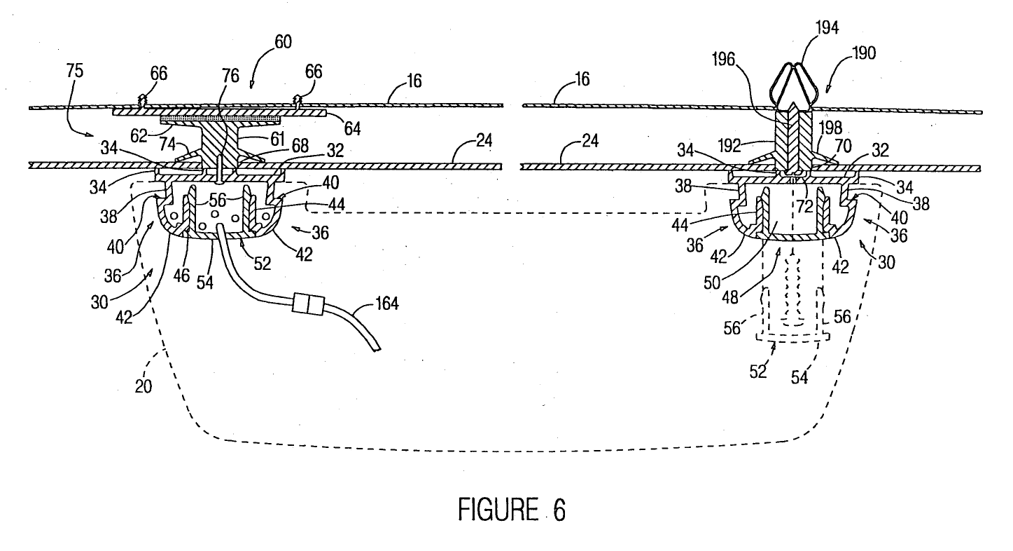

Referring to FIG. 6, the structural shape of elongated members 30 are shown according to one preferred embodiment. Elongated members 30 are shown having a generally hollow cross sectional shape, and include a generally flat base 32 (e.g. back, contact surface, etc.) on the top of elongated member 30 with several longitudinal ribs 34 projecting therefrom. Ribs 34 are provided at the outside edges and are intended to grip the surface of interior panel 24 and a pair of ribs 34 are located centrally for alignment with connectors 190 or 60 when elongated members 30 are secured to the roof structure. Elongated members 30 further include integral sides 36 having a recess 38 (e.g. notch, inset, slot, groove, channel, etc.) forming an outwardly projecting supporting ledge 40 (e.g. corner, shoulder, edge, etc.). Recesses 38 and ledges 40 provide an external structure for receiving and supporting the modules 20 (shown schematically) having corresponding structure adapted to mate with ledges 40. According to a particularly preferred embodiment, ledge 40 is horizontal (as shown) and ledge 40 and recess 38 are formed having an angle of 90 degrees or less for providing a structure for receiving modules 20. According to an alternative embodiment, the member may have a circular cross sectional shape (not shown) or any other suitable shape where the exterior surface is configured to provide mounting structure for receiving and supporting the modules (such as projecting flanges, apertures such as slots, grooves, holes, etc.). According to another alternative embodiment, the member may have a second recess and ledge (not shown) for providing an alternative mounting interface and providing structure adaptable for mounting “interlocks” that may prohibit or allow installation of certain modules along particular locations of the elongated members.

Beneath ledges 40, sides 36 are shown to include inwardly curved lower sections 42 that terminate into a return bend 44 providing internal corners 46 to create a longitudinal opening 48. Opening 48 creates a passage 50 (e.g. channel, path, conduit, tunnel, etc.) within elongated members 30 for routing utility carriers such as wires, cables, fiber optics, etc. as shown schematically in FIGS. 5 and 6. A removable cap 52 is provided generally along all or a portion of the length of elongated member 30 having a cover 54 to cover opening 48 and retain utility carriers, and may have a flush fit with member 30, or may have projecting contours, ribs, or other decorative or useful structure (not shown). Cap 52 is shown to include two inwardly projecting legs 56 that fit within opening 48 and are removably retained in place by an interference type, snap-fit engagement with return bends 44. Opening 48 may be entirely or partially concealed by inserting one or more caps 52 having segments of various lengths tailored to create an access pattern within elongated members 30. The access pattern may be created or modified at any time for selectively providing access to opening 48 along the length of elongated member 30. Elongated member 30 and cap 52 are preferably made of acrylonitrile butiadene styrene (ABS) plastic in an extrusion process, and may be provided in a wide variety of colors designed to accent an interior trim color scheme. According to an alternative embodiment, the elongated members and the cap may be made of aluminum or any other suitable material, wherein the elongated members or cap may also serve as a conductor for transmitting electrical power from a vehicle supply source to the modules mounted on the elongated members. The outer surface of the aluminum members is preferably anodized which is intended to provide an insulating layer on the exterior of the elongated member, which may be selectively removed to provide a custom-tailored electrical conductivity access pattern. Portions of elongated members 30 and cap 52 that are not otherwise enclosed by modules 20 may also have a separate insulating cover (not shown) configured to “snap-fit” into recesses 38 and ledges 40 to electrically isolate elongated members 30 from consumer contact or inadvertent contact with an electrical ground. Elongated members 30 and cap 52 may also be made of any other material suitable for forming an elongated support member and receiving mounting structure from modules 20 to be supported therefrom.

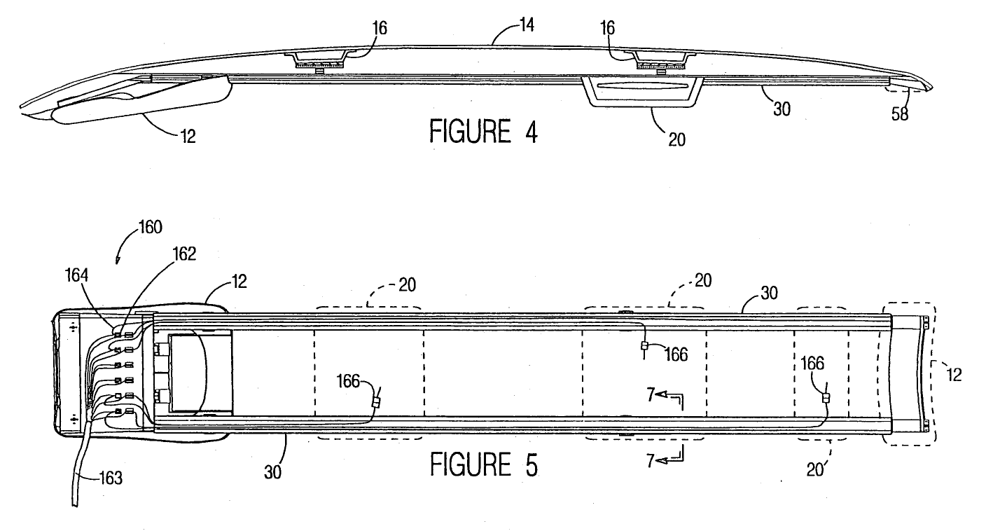

Referring to FIG. 4, elongated members 30 are shown secured to the vehicle according to a preferred embodiment. The ends of elongated members 30 are rigidly attached to the forward and rearward edges of the roof frame (e.g. beams, headers, bows, cross-pieces, etc.—not shown) by welding, brazing or fastening with conventional fasteners (not shown). Elongated members 30 may have ends attached directly to the frame, or elongated members 30 may be attached to the roof frame via fixtures shown schematically as brackets 58. Brackets may also be provided to support the ends of member segments that abut a roof discontinuity such as a sunroof, etc. The forward and rearward end connections of elongated members 30 are covered by suitable trim components shown schematically as a bezel or molding 12. Elongated members 30 may have a side profile that is straight, or a side profile that is slightly curved or bowed (not shown) to correspond with the panel profile 14 (shown as a roof panel). According to an alternative embodiment, the elongated members may be secured to door panel structures (not shown) or to pillars or other support columns (not shown) within the interior of the vehicle. Such support columns may be permanently fixed to the interior vehicle structure or may be removably or retractably attached to vehicle structure such as the floor, roof or sides of the vehicle to create a modular system for attaching modules within any interior location of a vehicle. According to a further alternative embodiment, the elongated members maybe mounted to the roof structure of the vehicle by connection devices such as “back brackets.” For example, the back bracket may have a first side that is attached directly to a structural portion of the roof (e.g. by clips or z-axis connectors, etc.) and the back bracket may have a second side that connects to the elongated members through an opening in the panel (e.g. headliner, etc.) so that the opening is concealed by a module, bezel, or other trim piece adapted for mounting on the elongated members.

Referring further to FIGS. 4 and 6, a structural support system for the interior span of elongated members 30 is shown according to a preferred embodiment. The interior span of elongated members 30 are coupled to the roof structure of the vehicle using a connector (e.g. Z-axis clips, etc.) having a spacer portion 192 with spring clip 194. A fastener 196 (e.g. threaded fasteners, etc.) may be used to secure elongated member 30 to spacer portion 192 and for securing spacer portion 192 to spring clip 194 to ensure the structural integrity of modular system 10. Spacer portion 192 may project through an aperture 70 in panel 24 to provide secure abutment with the back of elongated member 30, and supports 198 may project outwardly from spacer portion 192 to provide support to panel 24 around aperture 70. Connectors 190 are shown attached to one or more lateral frame members 16 (e.g. beams, roof bows, door panels, floor panels, cross headers, etc.) at a lateral position along frame member 16 corresponding to the installation position of elongated members 30. An alternative connector type may also be used such as that shown by connector 60 in FIG. 6. Connectors 60 have a spacer portion 61 and a base portion 62 coupled to a platform 64 that is attached to frame member 16 by finned-plugs 66 (e.g., “Christmas tree connectors”) or by a structural adhesive (not shown) such as “BETAMATE 73705” which is a polyurethane adhesive manufactured by the Dow Chemical Corporation and available through Sound Alliance, LLC located in Auburn Hills, Mich. According to an alternative embodiment, the connectors may be attached to frame member by a two-piece reclosable fastener system (not shown) such as “DUAL LOCK”® having mushroom-head shaped projections and manufactured by the Minnesota Mining and Manufacturing Company, or by a nylon “VELCRO”® hook and fastener structure available from Velcro USA Inc. located in Manchester, N.H. The end of connector 60 opposite from base 62 has a pedestal section 68 that extends through aperture 70 in panel 24 to engage base 32 of elongated member 30. The end of pedestal 68 is configured to abut ribs 34, and a projection 72 may be provided extending from the end of pedestal 68 and configured to be captured between longitudinal ribs 34 to improve lateral stability of elongated members 30. Connectors 60 are shown to further include supports 74 (wings, braces, arms, etc.) to support the back surface of panel 24 in the proximity of aperture 70. According to a preferred embodiment, connectors 190 and 60 are made from ABS, polycarbonate or other suitable plastic and spring clip 164 is made from heat-treated spring steel or wire, however, connectors 160 and 60 may have any suitable shape and material composition appropriate for transferring the load from system 10 through members 30 to frame member 16, and connector 60 may be attached to frame member 16 by any suitable means providing the appropriate tensile strength. Connectors 190 and 60 have a spacer length corresponding to the gap 76 between frame member 16 and panel 24. Following panel 24 installation over pedestal 68 of connectors 60 in the vehicle, elongated members 30 may be positioned over panel 24 and aligned with connectors 190 or 60, whereby members 30 are secured by a threaded fastener 196 or 76 through base 32 and into connector 190 or 60. According to alternative embodiments, other connector structures may be used such as solid blocks (not shown), and the panel may be provided without apertures whereby a fastener penetrates the base, panel and the connector. According to another alternative embodiment, the elongated members may be bowed into a shallow arch-like profile (not shown) and installed with a compression fit between the forward and rearward ends of the roof frame, or other vehicle structure such as floor and roof panels, thus obviating or minimizing the need for mid-span connectors. According to a further alternative embodiment, the elongated members may be mounted against panel and secured to the roof structure by back brackets, or alternatively panel segments may be positioned around, and supported by the elongated members.

Referring further to FIG. 1, a variety of modules 20 may be mounted to elongated members 30 according to any preferred embodiment. Modules 20 may include storage compartments (with or without key-lock access control) tailored to hold tissues, sunglasses, remote control devices, wireless phones, pagers, personal data assistants (PDA), walkie-talkies, binoculars, cameras, first aid or road-side emergency kits, tools, baby-care products and supplies, arts and crafts supplies, toys, sporting goods, books, maps, hunting and fishing equipment, and many other modules for which readily accessible storage in a vehicle may be useful. Such storage compartments may either be fixed or designed for pull-down, drop-down or rotational access where the compartment is recessed during storage and extended for access during usage. Modules 20 may also include handles, brackets, fixtures (e.g. starter block) for mounting racks, cages, or support pillars for optionally receiving elongated members 30 to mount additional modules 20 in a cargo area, lighting equipment, power adapters and outlets, lighters; visual display screens; audio equipment; media displays; digital video disc players; GPS receivers; cargo storage racks, air purifiers, straps or tie-downs; garment hangers, rods or racks; insulated hot or cold-storage containers, mobile office workstation components, portable air compressors or vacuum cleaners, cargo netting and holders; occupant safety features; specially-adapted consumer-use products such as travel tables, camping gear, pet barriers, luggage, etc.; brackets having rigid, swiveling or rotating couplers for removably receiving such consumer use products; storage racks having fixed or retractable support members for storing skis or other gear; and any other modules which may be useful in conjunction with traveling, working or other vehicle use.

Modules 20 are adapted to be selectively positionable along members 30, however, certain modules that may deemed to create a distraction to the vehicle operator, such as video displays and the like, may be provided with a mounting interlock feature intended to prevent their installation in certain “prohibited” positions along the elongated members, for example, allowing video monitors to be installed only in a rearward portion of the vehicle. The interlock function may be accomplished by altering the cross sectional shape or profile of a portion of the elongated members (not shown) or providing a second recess and ledge (not shown), or by providing suitable structure along the elongated members that is configured to mate with corresponding structure on particular module types. Particular modules 20 may be provided with a mounting profile for engaging members 30 that includes a projection (not shown) that extends into passage 50 whereby installation of a blank (not shown) within a particular portion of passage 50 along member 30 will prevent mounting such modules in the selected locations. Alternatively installation of the modules may be selectively restricted by otherwise altering the profile of the elongated members to fit only selected module mounting profiles and may be accomplished, for example, by adding a shim (not shown) along one or more sides of the elongated member or in connection with the passageway of the elongated member.

Modules 20 that are suitable for suspension from a single member are configured for attachment to a single elongated member 30 by having structure adapted to releasably connect with recess 38 and ledge 40 on each side of an elongated member 30. Modules 20 that are more suitable for suspension from two elongated members 30 are configured having a first coupling structure on one side of the module for attaching to the recess 38 and ledge 40 on one or both sides of the first elongated member 30, and are configured having a second coupling structure on the opposite side of the module for attaching to the recess 38 and ledge 40 on one or both sides of the second elongated member.

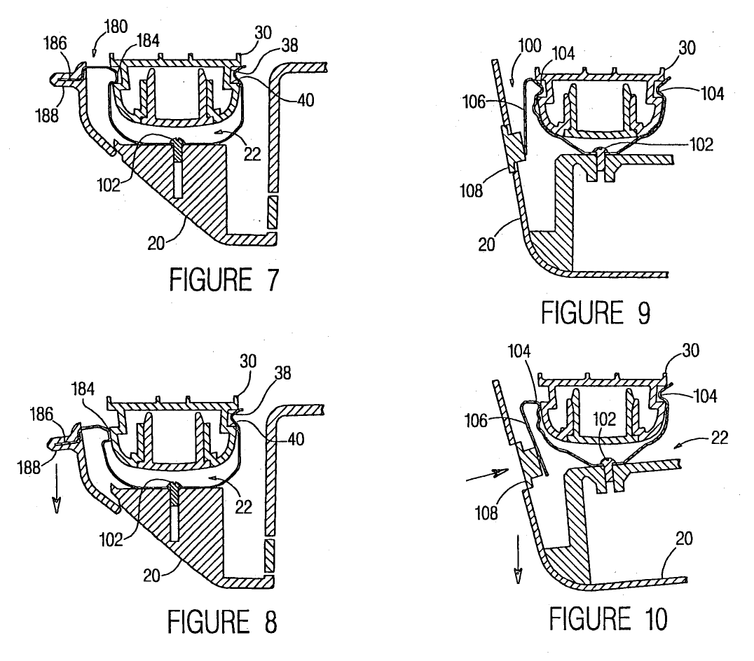

Referring to FIGS. 7 and 8, one embodiment of a coupling structure for attaching modules 20 to elongated members 30 is shown. A holder 180 (e.g. clamp, spring, clip, etc.) is positioned within an attachment profile 22 (e.g. channel, slot, groove, recess, valley, indent, etc.) on module 20 to align with elongated member 30 and is attached to module 20 in any suitable, such as by a conventional fastener 102 (shown as a threaded screw but may include finned plugs, adhesive, integral formation, etc.). Holder 180 is configured to resiliently conform to the exterior of elongated member 30 and is shown to include catches 184 (e.g. tabs, ears, dogs, etc.) that are biased inwardly to retain catches 184 within recesses 38 on one or both sides of elongated member 30, whereby catches 184 are vertically supported by ledges 40. A module 20 is configured to be removably attached to an elongated member 30 by aligning holder 180 beneath elongated member 30 and exerting a force on module 20 whereby catches 184 are biased around sides 36 and catches 184 resiliently fit within recesses 38, where ledge 40 is preferably horizontal (as shown) or angled upwardly and outward to form an angle of 90 degrees or less with recess 38 to ensure secure retention of catch 184. Holder 180 is shown to include an extension 186 fastened to a pivoting latch 188 on module 20. Extension 186 may be located on either side of holder 180 for a module 20 adapted for suspension from a single member 30, and extension 186 is shown as located on an exterior side of holder 180 for modules 20 that are adapted to be suspended from two elongated members 30. Pulling downward (or outward) on latch 188 causes catch 184 to release from recess 38 and allow module 20 to be removed from elongated member 30. The additional leverage created by releasing holder 180 from elongated member 30 on a first side of module 20 allows the holder 180 on a second member to be removed by rotating module 20 in a downward (or outward) direction. According to an alternative embodiment, an actuator and a clip having an extension may be positioned on each side of an module for improved ease in removing the module from members 30. According to a particularly preferred embodiment, holder 180 is made from spring steel stock having dimensions of approximately 1 millimeter thick but may be in the range of 0.5-2.0 millimeters or other dimensions suitable for providing a resilient holding function for module 20. However, other materials having suitable dimensions and the appropriate rigidity and resiliency such as plastic or hard rubber may be used for holders in alternative embodiments. Catches 184 on holder 180 may be adapted to engage recesses 38 having a height of approximately 9.2 millimeters and a depth of approximately 3.1 millimeters, but may be configured for a height in the range of 7 to 11 millimeters and the depth may be in the range of 2 to 5 millimeters or any other suitable dimensions according to customer specifications. Catches 184 on holder 180 may also be adapted to engage recesses 38 on each lateral side of elongated member 30 wherein the lateral space between the interior of recesses is approximately 33.8 millimeters, but may be in the range of 26 to 40 millimeters or any other dimensions suitable according to customer specifications. According to other alternative embodiments having modules adapted for suspension from two members, a holder on one side of an module may be replaced by a rigid fixture (not shown) designed to engage an exterior recess on a member, whereby the rigid fixture is positioned in place first, then the holder on the opposite side is rotated upward (or inward) and into an engaged position on its respective elongated member.

Referring to FIGS. 9 and 10, another embodiment of a coupling structure for attaching modules 20 to elongated members 30 are shown according to an exemplary embodiment. A holder 100 (e.g. clamp, spring, clip, etc.) is positioned within an attachment profile 22 (e.g. channel, slot, groove, recess, valley, indent, etc.) on module 20 to align with elongated member 30 and is attached to module 20 by a conventional fastener 102 (shown as a threaded screw but may include finned plugs, adhesive, integral formation, etc.). Holder 100 is configured to resiliently conform to the exterior of member 30 and includes catches 104 (e.g. tabs, ears, dogs, etc.) that are biased inwardly to retain catches 104 within recesses 38 on one or both sides of elongated member 30, whereby catches 104 are vertically supported by ledges 40. A module 20 is configured to be removably attached to elongated member 30 by aligning holder 100 beneath member 30 and exerting a force on module 20 whereby catches 104 are biased around sides 36, so that catches 104 resiliently fit within recesses 38, where ledge 40 is preferably configured horizontally (as shown) or angled upward and outward to form an angle of 90 degrees or less relative to recess 38. Holder 100 includes an extension 106 configured to resiliently contact an actuator 108 (e.g. pushbutton, etc.) on a module that has a relative vertical position below ledge 40. Extension 106 may be located on either side of holder 100 for an module 20 adapted for suspension from a single member 30, and extension 106 is located on exterior side of holder 100 for modules 20 adapted to be suspended from two elongated members 30. Extension 106 has a return bend generally in the shape of an inverted “U” and has sufficient stiffness so that manually depressing actuator 108 will outwardly deflect catch 104 sufficiently to clear ledge 40 by simultaneously pulling downward on module 20. The additional leverage created by releasing a holder 100 from a member 30 on a first side of module 20 is intended to allow the holder 100 on a second elongated member to be removed by rotating module 20 in a downward (or outward) direction. According to an alternative embodiment, an actuator and a clip having an extension may be positioned on each side of a module for improved ease in removing the module from the elongated members. According to another alternative embodiment having modules adapted for suspension from two elongated members, a holder on one side of a module may be replaced by a rigid fixture (not shown) designed to engage an exterior recess on a member, whereby the rigid fixture is positioned in place first, then the holder on the opposite side is rotated upward (or inward) and into an engaged position on its respective member.

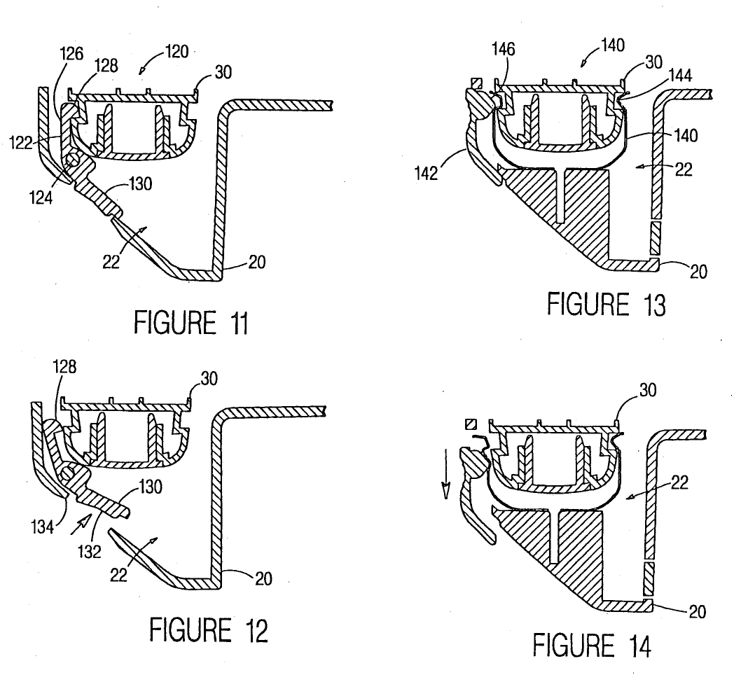

Referring to FIGS. 11 and 12, another embodiment of a coupling structure for attaching modules 20 to elongated members 30 is provided according to another exemplary embodiment. A holder 120 includes a latch 122 (e.g. hook, catch, clasp, etc.) pivotally attached to module 20 at pivot 124 in a position aligned with an outward side of an elongated member 30. Latch 122 has an upper end 126 above pivot 124 with a projection 128 extending inwardly therefrom that is shaped to engage recess 38 and ledge 40 of member 30. Latch 122 also has a lower end 130 below pivot 124 that includes an actuator portion 132 cooperating with an aperture 134 in module 20. Latch 122 is biased so that projection 128 is urged inwardly and actuator 132 is urged outwardly. Biasing of latch 122 may be accomplished by a coil spring (not shown) operating about the axis of pivot 124, or by a leaf spring (not shown) positioned between module 20 and upper end 126. Latch 122 is shown having an obtuse angle shape but may have any suitable shape adapted to provide an actuator surface on module 20 and for engaging elongated member 30. Latch 122 may be used in conjunction with an module adapted for suspension from a single elongated member 30, where a single latch 122 is used to engage recess 38 one side of an elongated member 30, and module 20 includes a rigid structure (not shown) designed to engage recess 38 on the opposite side of member 30. Such a module 20 may be removably attached to an elongated member 30 by inserting the rigid structure over ledge 40 and exerting a force on the opposite side of module 20 whereby latch 122 resiliently rides over outward side 36 of elongated member 30 and engages recess 38. Latch 122 may also be used in conjunction with a module 20 adapted for suspension from two parallel elongated members 30, where a latch 122 is positioned on one or both sides of module 20 to engage a recess 38 and ledge 40 on the outward side 36 of members 30. Where a latch 122 is used on only one side of such a module 20, a rigid structure (not shown) would be provided on the opposite side of module 20, whereby module 20 is installed by first engaging the rigid structure to recess 38 and then exerting an upward (or inward) force on the opposite side of module 20 whereby latch 122 resiliently rides over outward side 36 of the elongated member and engages recess 38. In any configuration, module 20 may be selectively released by depressing actuator 132 to disengage projection 128 from recess 38 and then pulling and/or rotating module 20 downward (or outward).

Referring to FIGS. 13 and 14, another embodiment of a coupling structure for attaching modules 20 to members 30 is provided according to a further exemplary embodiment. A latch 142 is coupled to module 20 and configured for vertical sliding engagement with a holder 140. Holder 140 is coupled to module 20 and positioned for alignment with elongated member 30. Holder 140 is generally “U” shaped to fit around elongated member 30, and configured with inwardly projecting catches 144 for engaging recesses 38. The side of holder 140 oriented to engage latch 142 is outwardly biased whereby sliding latch 142 downward will allow catches 144 to deflect outward for removal or installation of module 20. Latch 142 is coupled to module 20 in a manner that permits vertically slidable operation, whereby detent 146 on latch 142 provides a resistance closure with latch 142 in the upward position and catch 144 engaged within recess 38.

According to other alternative embodiment, the holders may be replaced with fasteners (e.g. set screws configured to engage the recess, etc.) that may be loosened for installation of a module on the members and then the fastener may be tightened to secure the module to the member, or loosened for subsequent repair, replacement, or reorientation within the vehicle. According to further alternative embodiments, the coupling structure for securing the modules to the elongated member(s) may be provided as slide latches (e.g. Y-axis or Z-axis, etc.), pivot latches, over-center type latches, etc.

Referring to FIGS. 3 and 5, a utility interface 160 for system 10 is shown schematically according to a preferred embodiment. Interface 160 is included within the cover 12 for communicating with passageways through the roof structure (not shown) and interfacing with elongated members 30. Interface 160 includes a series of ports 162 (e.g. connectors, receptacles, jacks, plugs, etc.) for facilitating the interconnection of conventional utility carriers 163 (e.g. wires, cables, conductors, harnesses, etc.) for delivering utilities (e.g. electrical power, voice and data communication signals, RF transmission signals, instrumentation signals, vehicle identifier information, etc.) between a supply source (not shown) and modules 20 mounted to elongated members 30. Utilities may be routed from a vehicle supply source (e.g. a battery, antenna, receiver, transmitter, etc.—not shown) through utility carriers 163 that interconnect the vehicle supply source and the ports 162 provided in interface 160. Utility interface 160 may be provided in either the forward or rearward portion of the vehicle, or other suitable location.

According to another preferred embodiment, utilities may be distributed from interfaces 160 via additional utility carriers 164 that interconnect between interfaces 160 and modules 20. The utility carriers 164 may be distributed throughout modular system 10 by routing the carriers 164 through passage 50 in elongated members 30 where the carriers 164 are concealed behind cover 54 (shown in FIG. 6) and modules 20. Modules 20 are mounted over elongated members 30 and cover segments 54, whereby one or more gaps or other openings corresponding to access and egress locations for utilities carriers 164, interfacing with modules 20 may be provided in cover 54, behind module 20, to create a utilities access pattern. The access pattern is adaptable to future changes or modifications in the module selection package by making suitable changes in the removable cover 54 of elongated members 30. Modules 20 and utility carriers 164 may be provided with mating connectors 166 to facilitate ease of installation, replacement or reconfiguration of modules 20 within the system 10. Alternatively, the modules may be provided with a fixed length of utility carrier for routing through the passage to the interface, where the utility carrier includes a terminal at the outward end configured for directly connecting with the interface. To provide additional flexibility in distributing utilities to various modules, a module may be configured to serve as a utility storage or junction box for housing additional utility distribution devices or components and for storing excess quantities of utility carrier that may be desirable for accommodating future changes to the module selection package.

According to an exemplary embodiment, low-voltage electrical power in the range of approximately 12-42 volts DC or other suitable voltage range for powering the modules may be routed to the modules via the elongated members, where the members are fabricated entirely or partially from aluminum or other electrically conductive material. The members may also be fabricated from a non-conducting material such as plastic, where a conducting material such as copper or aluminum is integrally formed with the elongated member in the shape of a longitudinal conducting strip, rail or bar to provide an electric current access path from the interface to the modules. Such conducting material may be affixed to the elongated member by ultrasonic welding, molding, interference-type snap insert, vacuum metallization, etc. The modules may be provided with an electrically conductive contactor that projects from a surface of the module (e.g. spring biased, etc.) and is configured to contact the member (or a conducting strip thereon) and remains concealed between the elongated member and the module when the module is installed on the elongated member to provide a conductive electrical path to the module. The contactor may be spring-biased for urging the contactor into continuous contact with the elongated member or a conducting strip when the module is mounted on the elongated members. Where a system with two parallel elongated members are used, one elongated member may have a positive electrical polarity (i.e. battery potential) and the second elongated member may have a negative electrical polarity (i.e. ground). For embodiments using a single elongated member, two longitudinal conducting strips (not shown) may be used on the elongated member to provide positive and negative conductors, corresponding to appropriately positioned contactors on the module that is configured to mount to a single elongated member.

Conducting strips may be used as an interlock for positioning modules along the elongated members by altering the conducting strip longitudinal position along the elongated member to provide a power interlock profile. The power interlock profile is intended to ensure that contactors for certain modules will properly interface with the conducting strips only when modules are installed at predetermined locations on the elongated members corresponding to a mating conducting strip position. For example, video display modules may have contactors positioned to match a conducting strip position corresponding only to a location rearward of the front seats of the vehicle. Similarly, other consumer modules that may create a distraction to a vehicle operator may be electrically interlocked so that they are operable only when installed in positions that are preestablished by the power interlock profile. Insulating cover segments may be provided that are adapted to cover or otherwise at least partially enclose portions of the elongated members that remain exposed after installation of the module(s) to prevent consumer exposure or electrical shorts to ground with the energized portions of the modular system.

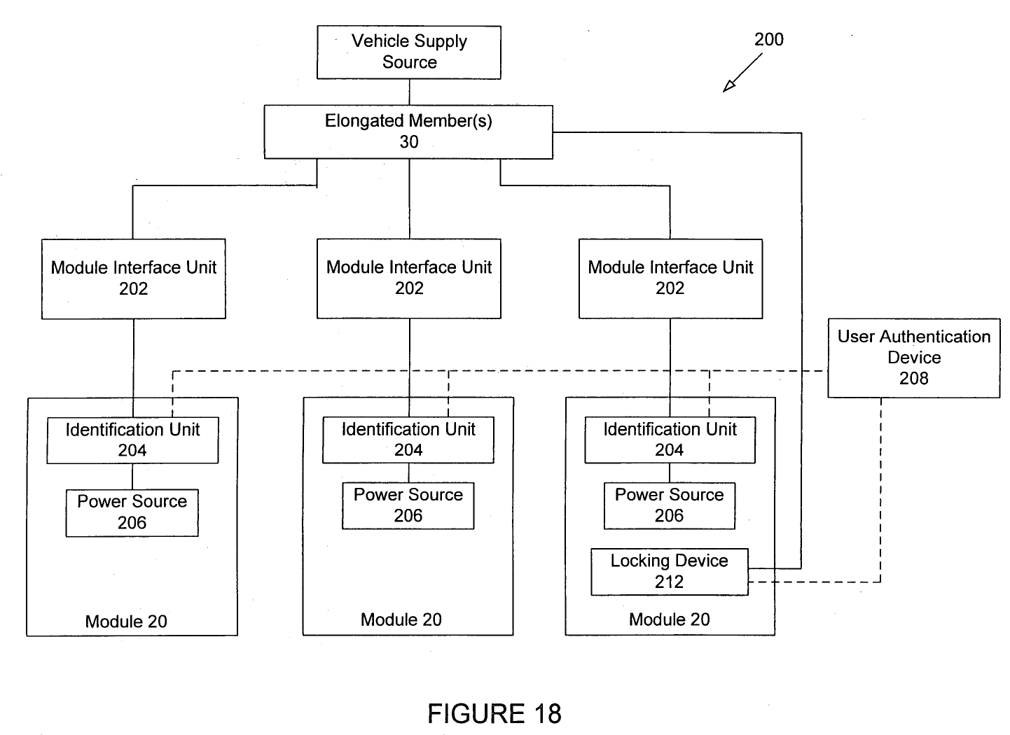

Referring to FIG. 18, a security system 200 for use with modules 20 on a modular system in a vehicle is shown according to an exemplary embodiment. According to any exemplary embodiment, the security system is intended to prevent or deter unauthorized modules from being operated with the modular system and to prevent or deter unauthorized removal of a module from the modular system (e.g. theft, etc.). According to the exemplary embodiment shown schematically in FIG. 18, the security system 200 is intended to “bond” a particular module with the module's intended vehicle so that the module will be operational only in the intended vehicle. When the module is removed from the intended vehicle the system is configured to prevent the module from operating in an unintended vehicle unless the module is reconfigured for use with another vehicle (e.g. by an authorized service provider, etc.).

According to an exemplary embodiment, the elongated members 30 of the modular system provide a source of power and communication from a vehicle supply source 210 to the modules 20 in any suitable manner, such as previously described (e.g. conductive elements provided on the elongated members, separate conductors routed within the elongated members and provided with suitable contacts or connectors, etc.). The communication signals include any suitable communication signal intended for operation of the module 20, and a signal representative of a unique identity of the vehicle (the “vehicle identifier” such as a predetermined identification number or code, which may be “random” or may include the vehicle identification number (VIN) or other suitable identifier). A module interface unit 202 is provided on the elongated member 30 and is configured to mate or otherwise correspond with a module 20 and to provide an interface for power and communication signals from the elongated members 30 to the module 20. According to an exemplary embodiment, module interface unit 202 includes suitable software for storing and communicating the vehicle identifier to the modules. The module interface unit may further include an algorithm configured to “scramble” or otherwise provide encryption of the vehicle identifier to provide enhanced security of the system.

The module 20 includes an embedded identification unit 204 and an internal power source 206 (such as a lithium battery or the like) configured to provide a limited source of power for operation of the identification unit 204. The identification unit 204 is programmed to include the vehicle identifier for the specific vehicle(s) for which the module 20 is intended for use, and is retained within the identification unit 204 (e.g. by non-volatile memory or the like). The identification unit may also include an algorithm configured to “scramble” or otherwise provide encryption for the vehicle identifier. According to one exemplary embodiment, the vehicle identifier can be programmed in the identification unit 204 at a factory (e.g. for pre-ordered modules intended for use with the modular system) or programmed by an authorized supplier of the modules (e.g. for after-market or dealer-provided accessories, etc.).

According to another exemplary embodiment, the identification unit 204 may be supplied without a vehicle identifier, which may be locally programmed by a user with a user authentication device 208 that communicates the vehicle identifier to the identification unit 204. The user authentication device 208 may be, for example, a key fob or other wireless or contact-operated handheld device having the vehicle identifier programmed therein, and configured to transmit the vehicle identifier to the identification unit 204. The user authentication device 208 may communicate the vehicle identifier to the identification unit 204 by a wireless signal such as infrared (IR) or radio frequency (RF), or by direct contact. When the user authentication device 208 operates by wireless communication, the transmission beam is preferably sufficiently “localized” and “narrow” so that the communication is not unintentionally received by other modules on the modular system.

When the module 20 is attached to the elongated members 30, the internal power source 206 is configured to activate the identification unit 204 and enable communications between the identification unit 204 and the module interface unit 202. According to one exemplary embodiment, the identification unit “requests” authorization by transmitting the vehicle identifier stored in the identification unit 204 to the module interface unit 202. The module interface unit 202 “decrypts” the vehicle identifier provided by the identification unit 204. If the vehicle identifier in the module interface unit 202 “matches” the vehicle identifier in the identification unit 204, then the module interface unit 202 “reports” to the identification unit 204 that the module 20 and the vehicle have successfully “bonded” or “matched” and the module 20 is thus “authenticated” for use with the vehicle. Upon authenticating the module 20, the module interface unit 202 is enabled to provide power and communication signals to the module 20. If the module 20 is not “authenticated” then the module interface unit 202 is not enabled and power and communication signals are not provided to the module 20. This feature is intended to prevent the use of unauthorized modules on a particular modular system in a vehicle. Unauthorized modules may be those that are produced by an unauthorized manufacturer, or those that are obtained from an otherwise unauthorized source (e.g. stolen, etc.). According to an alternative embodiment, the user authentication device may be configured to provide the vehicle identifier to the identification unit if the vehicle identifier is not present in the identification unit.

In the event that power is lost or otherwise interrupted to the module 20, upon reintroduction of power, the module interface unit 202 and the identification unit 204 will attempt to reestablish a “link” by matching their respective vehicle identifiers. If the link is reestablished, then delivery of power and communication signals to the module 20 by the module interface unit 202 is resumed. If the link is not reestablished, then the module interface unit 202 is not enabled to provide power and communication signals to the module 20. This feature is intended to prevent removal of a module from one vehicle (e.g. by theft, etc.) and reintroduction for use with a modular system in an unauthorized vehicle.

According to an alternative embodiment, the identification unit may be configured to be programmed with several vehicle identifiers, such as when a user wishes to use the module interchangeably between two or more authorized vehicles.

According to another exemplary embodiment, the module may be provided with a locking device 212 (such as an electrically-actuated latch, bolt, pin, bracket, etc.). The locking device 212 is configured to actuate (e.g. “lock”) and retain the module 20 on the elongated member 30 when the identification unit 204 is authenticated by the module interface unit 202. Once activated, locking device 212 is then configured to deactivate (e.g. “unlock”) upon receiving an authenticating signal from the user authentication device 208, and is intended to prevent removal of the module 20 from the elongated member 30 without proper authentication from the authorized user. The locking device may be configured so that when the user authentication device 208 activates the locking device 221 for removal of the module 20, the vehicle identifier is “deactivated” (e.g. removed, etc.) from the identification unit 204. The vehicle identifier could be “reactivated” in the identification unit by the user authentication device for reinstallation in an authorized vehicle so that the module could be authenticated by a authorized user with an authorized vehicle, but would be intended to be unable to be authenticated for subsequent use in an unauthorized vehicle without being “reprogrammed” by an authorized service provider (e.g. dealer, factory, service center, etc.). This feature is also intended to prevent removal of a module from one vehicle (e.g. by theft, etc.) and reintroduction for use with a modular system in an unauthorized vehicle.

It is important to note that the construction and arrangement of the elements of the security system for a modular system in a vehicle provided herein is illustrative only. Although only a few exemplary embodiments of the present invention have been described in detail in this disclosure, those skilled in the art who review this disclosure will readily appreciate that many modifications are possible in these embodiments (such as variations in installation location and orientation within a vehicle, sizes, structures, shapes and proportions of the various elements, mounting arrangements, use of materials, colors, combinations of shapes, etc.) without materially departing from the novel teachings and advantages of the invention. For example, the security system for a modular system may be used with any vehicle (such as an automobile, truck, sport utility vehicle, van, boat, airplane, train, construction or farming equipment, tractor trailer trucks, motor homes and recreational vehicles, etc.). Further, it is readily apparent that elongated members may be provided in a wide variety of shapes, sizes, thickness, and engagement profiles and adapted for installation along the roof, floor and sides of a vehicle, or within a cargo area or other suitable location within a vehicle. It is also readily apparent that the modules may be designed with any profile suitable for attaching to one or more members and may be adapted for slidable movement along the members. Accordingly, all such modifications are intended to be within the scope of the invention as defined in the appended claims.

What is claimed is:

1. A security system for a modular system for a vehicle, comprising:
at least one elongated member configured for attachment to an interior portion of the vehicle;
at least one module configured for attachment to the elongated member;
a module interface unit communicating with the elongated member;
an identification unit coupled to the module and configured to interface with the module interface unit;
so that the module interface unit is operable to authenticate the module when the module is mounted on the elongated member.

2. The security system of claim 1 wherein the module interface unit is coupled to the elongated member.

3. The security system of claim 1 wherein the module interface unit is configured to provide electrical power to the module when the module is authenticated.

4. The security system of claim 1 wherein the module interface unit is configured to provide at least one communication signal to the module when the module is authenticated.

5. The security system of claim 1 wherein the module interface unit comprises a first identifier representative of the vehicle.

6. The security system of claim 5 wherein the identification unit comprises a second identifier representative of the vehicle.

7. The security system of claim 6 wherein the module is authenticated when the first identifier representative of the vehicle corresponds to the second identifier representative of the vehicle.

8. The security system of claim 1 wherein the module further comprises a power source configured to activate the identification unit.

9. The security system of claim 1 further comprising a user authentication device.

10. The security system of claim 9 wherein the user identification device is configured to provide a signal representative of an identifier of the vehicle to the module.

11. The security system of claim 10 wherein the user identification device is a key fob.

12. The security system of claim 10 wherein the user identification device is configured to communicate with the module by one or more of an infrared signal, a radio frequency signal and a contact interface.

13. The security system of claim 1 further comprising a vehicle supply source configured to provide electrical power and a communication signal to the module interface unit.

14. The security system of claim 1 wherein the module is configured for removable attachment to the elongated member.

15. The security system of claim 1 wherein the elongated member is mounted on an overhead portion of the interior portion of the vehicle.

16. A security system for a module adapted for use with a modular system for a vehicle, comprising:
at least one elongated member configured for attachment to an interior portion of the vehicle and configured to receive the module;
a module interface unit communicating with the elongated member;
an identification unit coupled to the module and configured to interface with the module interface unit; and
a locking device provided on the module and operable to engage the elongated member in a locked position and a released position.

17. The security system of claim 16 wherein the module interface unit comprises information representative of a first vehicle identifier.

18. The security system of claim 17 wherein the identification unit comprises information representative of a second vehicle identifier.

19. The security system of claim 18 wherein the locking device is configured to actuate to the locked position when the module is mounted on the elongated member and the first vehicle identifier matches the second vehicle identifier.

20. The security system of claim 18 further comprising a user authentication device having information representative of a third vehicle identifier and configured to communicate with the module.

21. The security system of claim 20 wherein the locking device is configured to actuate to the released position when the module receives a signal representative of the third vehicle identifier that matches the signal representative of the second vehicle identifier.

22. A modular system for a vehicle, comprising:
at least one elongated member configured for installation on an interior surface of the vehicle;
a module configured to couple to the elongated member;
a vehicle supply source configured to provide at least one of an electrical power supply and a communication signal for use by the module;
a module interface unit configured to interface with the vehicle supply source and the module;
an identification unit coupled to the module and configured to authenticate the module for use in the vehicle so that the module interface unit is enabled to provide at least one of an electrical power supply and a communication signal to the module.

23. The modular system of claim 22 wherein the module interface unit is encoded with a first vehicle identifier.

24. The modular system of claim 23 wherein the identification is encoded with a second vehicle identifier.

25. The modular system of claim 23 wherein the module is authenticated for use with the vehicle only when a corresponding relationship is established between the first vehicle identifier and the second vehicle identifier.

26. The modular system of claim 22 further comprising a user authentication device configured to interface with the identification unit.

27. The modular system of claim 22 wherein the module further comprises a locking device operable to engage the elongated member if the module is authenticated for use with the vehicle.

28. The modular system of claim 26 wherein the locking device is operable to disengage the elongated member when an authenticated signal is provided by a user authentication device.
